(19) United States
(12) Patent Application Publication
(10) Pub. No.: US 2026/0071647 A1
(43) Pub. Date: Mar. 12, 2026

(54) ROTATING BIT WITH INTEGRAL WASHER FEATURE

(71) Applicant: The Sollami Company, Herrin, IL (US)

(72) Inventor: Phillip Sollami, Herrin, IL (US)

(73) Assignee: The Sollami Company, Herrin, IL (US)

(21) Appl. No.: 19/281,721

(22) Filed: Jul. 27, 2025

Related U.S. Application Data
(63) Continuation-in-part of application No. 19/193,861, filed on Apr. 29, 2025.
(63) Continuation-in-part of application No. 18/931,855, filed on Oct. 30, 2024.
(63) Continuation-in-part of application No. 18/437,987, filed on Feb. 9, 2024.
(63) Continuation-in-part of application No. 18/236,672, filed on Aug. 22, 2023.
(63) Continuation-in-part of application No. 18/134,659, filed on Apr. 14, 2023, now abandoned.
(63) Continuation-in-part of application No. 18/102,311, filed on Jan. 27, 2023.
(63) Continuation-in-part of application No. 18/059,662, filed on Nov. 29, 2022.
(63) Continuation-in-part of application No. 17/970,325, filed on Oct. 20, 2022.
(60) Provisional application No. 63/466,041, filed on May 12, 2023.
(60) Provisional application No. 63/547,036, filed on Nov. 2, 2023.
(60) Provisional application No. 63/621,178, filed on Jan. 16, 2024.
(60) Provisional application No. 63/640,040, filed on Apr. 29, 2024.
(60) Provisional application No. 63/676,221, filed on Jul. 26, 2024.
(60) Provisional application No. 63/692,764, filed on Sep. 10, 2024.
(60) Provisional application No. 63/750,354, filed on Jan. 28, 2025.

(51) Int. Cl. F16B 43/00

(52) U.S. Cl. CPC F16B 43/004

(57) ABSTRACT

A bit including a bit body and a shank depending from a bottom of the bit body. The bit body including an integral washer portion that extends to a rear annular flange and a tapered portion adjacent the rear annular flange that is complementary to an angle of a countersink at a forward end of a bore of a bit holder, radially aligning the bit concentric with the bore of the bit holder. The shank comprises a cap distal portion including a diameter that is less than or equal to a diameter of a forward portion of the shank. The bit includes a retainer disposed circumferentially about the shank, the retainer including a reduced diameter distal section allowing the bit to be manually inserted into the bore of the bit holder a predetermined distance before needing to resort to hammer hits to securely mount the bit in the bore of the bit holder while still allowing the bit to freely rotate within the bore of the bit holder.

### CROSS-REFERENCE TO RELATED APPLICATION(S)

This application claims priority to U.S. Provisional Application No. 63/676,221, filed Jul. 26, 2024, claims priority to and is a continuation-in-part of U.S. Provisional Application No. 63/692,764, filed Sep. 10, 2024, claims priority to and is a continuation-in-part of U.S. Provisional Application No. 63/750,354, filed Jan. 28, 2025, claims priority to and is a continuation-in-part of U.S. Provisional Application No. 63/621,178, filed Jan. 16, 2024, claims priority to and is a continuation-in-part of U.S. Non-provisional application Ser. No. 17/970,325, filed Oct. 20, 2022, claims priority to and is a continuation-in-part of U.S. Non-provisional application Ser. No. 18/059,662, filed Nov. 29, 2022, claims priority to and is a continuation-in-part of U.S. Non-provisional application Ser. No. 18/102,311, filed Jan. 27, 2023, claims priority to and is a continuation-in-part of U.S. Non-provisional application Ser. No. 18/134,659, filed Apr. 14, 2023, claims priority to and is a continuation-in-part of U.S. Provisional Application No. 63/466,041, filed May 12, 2023, claims priority to and is a continuation-in-part of U.S. Non-provisional application Ser. No. 18/236,672, filed Aug. 22, 2023, claims priority to and is a continuation-in-part of U.S. Non-provisional application Ser. No. 18/931,855, filed Oct. 30, 2025, claims priority to and is a continuation-in-part of U.S. Provisional Application No. 63/547,036, filed Nov. 2, 2023, claims priority to and is a continuation-in-part of U.S. Provisional Application No. 63/621,178, filed Jan. 16, 2024, claims priority to and is a continuation-in-part of U.S. Non-provisional application Ser. No. 18/437,987, filed Feb. 9, 2024, claims priority to and is a continuation-in-part of U.S. Non-provisional application Ser. No. 19/193,861, filed Apr. 29, 2025, and claims priority to and is a continuation-in-part of U.S. Provisional Application No. 63/640,040, filed Apr. 29, 2024, to the extent allowed by law and the contents of which are incorporated herein by reference in their entireties. The contents of Applicant's co-pending U.S. Non-provisional Application No. U.S. Non-provisional application Ser. No. 19/180,973, filed Apr. 16, 2025, Applicant's expired U.S. Provisional Application No. 63/634,745, filed Apr. 16, 2024, Applicant's co-pending U.S. Non-Provisional application Ser. No. 17/877,084, filed Jul. 29, 2022, Applicant's issued U.S. Non-Provisional application Ser. No. 17/146,992, filed Jan. 12, 2021, now U.S. Pat. No. 11,891,825, issued Feb. 6, 2024, Applicant's expired U.S. Provisional Application No. 62/898,654, filed Sep. 11, 2019, Applicant's expired U.S. Provisional Application No. 62/965,237, filed Jan. 24, 2020, Applicant's U.S. Pat. No. 10,107,098, issued Oct. 23, 2018, and Applicant's U.S. Pat. No. 10,612,376, issued Apr. 7, 2020, are incorporated herein by reference in their entireties

### TECHNICAL FIELD

This disclosure relates to a bit and/or pick for road milling, mining, and trenching equipment, and more particularly, to a rotating bit including a washer feature.

### BACKGROUND

Road milling, mining, and trenching equipment utilizes bits and/or picks traditionally set in a bit assembly. Bit assemblies can include a bit and/or pick retained within a bore in a base block. Bit assemblies can also include a bit and/or pick retained by a bit holder and the bit holder retained within a bore in a base block. A plurality of the bit assemblies are mounted on the outside of a rotatable drum, typically in a V-shaped or spiral configuration. A plurality of the bit assemblies can also be mounted on an endless chain and plate configurations. The combinations of bit assemblies have been utilized to remove material from the terra firma, such as degrading the surface of the earth, minerals, cement, concrete, macadam or asphalt pavement. Individual bits and/or picks, bit holders, and base blocks may wear down or break over time due to the harsh road degrading environment. Additionally, the forces and vibrations exerted on the bit assemblies may cause the bit and/or pick to wear away the bore in the base block, the bit and/or pick to wear away the bore in the bit holder, or the bit holder to wear away the bore in the base block. For rotating bits, a slotted retainer, sleeve, and washer disposed circumferentially around the bit shank, for example, are used to maintain the bit in the bit holder. Over time, a gap forms between a bottom of the bit body and a forward face of the bit holder and the gap between a distal end of a sleeve and a forward end of a retainer continues to increase, allowing dirt, debris, and fines to enter the space between the outer diameter of the bit shank and the inner diameter of the retainer, resulting in poorer rotation of the bit, reducing the life of a carbide tip of the bit and increasing the bit holder bore wear, thereby requiring replacement of the bit, bit holder, and/or base block long before the standard minimum lifetime required by the industry.

To prolong the life of the bit assembly, and the bit holder and/or the base block, a bit and/or pick comprising a washer feature incorporated into the body of the bit and a slotted retainer with varying features adjacent a distal end of the retainer will ease the insertion of the bit into the bit holder, reduce costs, reduce axial movement, and form nearly 100 percent sealed areas between the inner diameter of the retainer and the outer diameter or the shank, between the bottom of the bit and the retainer, and between the retainer and the bore of the bit holder, thereby providing nearly 100 percent uninhibited rotation of the bit, increasing the life of the bit tip insert of the bit due to improved rotation, and increasing the overall life span of the bit, bit holder, and base block.

### SUMMARY

This disclosure relates generally to bit and/or pick assemblies for road milling, mining, and trenching equipment. One implementation of the teachings herein is a retainer that includes a body portion including an axial forward end and an axial distal end; a first slot extending through a sidewall of the body portion from the axial forward end to the axial distal end; and a reduced diameter distal section adjacent the axial distal end of the retainer, the reduced diameter distal section including an outer diameter that is less than an outer diameter of the body portion of the retainer forward of the reduced diameter distal section.

In another implementation of the teachings herein is a bit that includes a unitary body portion including a washer portion adjacent a distal end of the unitary body portion, the washer portion integrally formed as part of the unitary body portion; the unitary body portion axially and radially extending to a transition adjacent an outer diameter of the washer portion; a generally cylindrical shank depending from a bottom of the body portion; and a generally cylindrical hollow retainer disposed circumferentially about the shank, the retainer including a body portion including an axial forward end and an axial distal end; a first slot extending through a sidewall of the body portion from the axial forward end to the axial distal end; and a reduced diameter distal section adjacent the axial distal end of the retainer, the reduced diameter distal section including an outer diameter that is less than an outer diameter of the body portion of the retainer forward of the reduced diameter distal section.

These and other aspects of the present disclosure are disclosed in the following detailed description of the embodiments, the appended claims and the accompanying figures.

### BRIEF DESCRIPTION OF THE DRAWINGS

The various features, advantages, and other uses of the apparatus will become more apparent by referring to the following detailed description and drawings, wherein like reference numerals refer to like parts throughout the several views. It is emphasized that, according to common practice, the various features of the drawings are not to-scale. On the contrary, the dimensions of the various features are arbitrarily expanded or reduced for clarity.

FIG. 1 is a distal end perspective view of a first illustrated embodiment of a bit in accordance with implementations of this disclosure;

FIG. 2 is a forward end perspective view of the first illustrated embodiment of the bit in accordance with implementations of this disclosure;

FIG. 3 is a side elevation view of the first illustrated embodiment of the bit in accordance with implementations of this disclosure;

FIG. 4 is a distal end perspective view of a second illustrated embodiment of a bit in accordance with implementations of this disclosure;

FIG. 5 is a forward end perspective view of the second illustrated embodiment of the bit in accordance with implementations of this disclosure;

FIG. 6 is a side elevation view of the second illustrated embodiment of the bit in accordance with implementations of this disclosure;

FIG. 7 is a distal end perspective view of a third illustrated embodiment of a bit in accordance with implementations of this disclosure;

FIG. 8 is a forward end perspective view of the third illustrated embodiment of the bit in accordance with implementations of this disclosure;

FIG. 9 is a forward end elevation view of the third illustrated embodiment of the bit in accordance with implementations of this disclosure;

FIG. 11 is an exploded side elevation view of a first illustrated embodiment of a bit assembly, including the first illustrated embodiment of the bit, a first illustrated embodiment of a retainer, a bit holder, and a base block, with invisible internal components shown in dotted lines in accordance with implementations of this disclosure;

FIG. 11A is a side elevation view of the second illustrated embodiment of the bit as an alternate replacement part for the bit of the bit assembly of FIG. 11 in accordance with implementations of this disclosure;

FIG. 11B is a side elevation view of the third illustrated embodiment of the bit as an alternate replacement part for the bit of the bit assembly of FIG. 11 in accordance with implementations of this disclosure;

FIG. 12 is an exploded side elevation view of the first illustrated embodiment of the bit assembly, showing the first illustrated embodiment of the bit assembled with the first illustrated embodiment of the retainer and the bit holder assembled with the base block, in accordance with implementations of this disclosure;

FIG. 13 is a side elevation view of the first illustrated embodiment of the bit, shown assembled with the first illustrated embodiment of the retainer, with invisible internal components shown in dotted lines, in accordance with implementations of this disclosure;

FIG. 14 is a rear elevation view of the first illustrated embodiment of the bit assembly in accordance with implementations of this disclosure;

FIG. 15 is a cross-sectional view of the first illustrated embodiment of the bit assembly taken along Line A-A of FIG. 14 in accordance with implementations of this disclosure;

FIG. 16 is a rear perspective view of a fourth illustrated embodiment of a bit, shown assembled with a second illustrated embodiment of a retainer, in accordance with implementations of this disclosure;

FIG. 17 is a front perspective view of the fourth illustrated embodiment of the bit, shown assembled with the second illustrated embodiment of the retainer, in accordance with implementations of this disclosure; and

FIG. 18 is a side elevation view of the fourth illustrated embodiment of the bit, shown assembled with the second illustrated embodiment of the retainer, in accordance with implementations of this disclosure.

### DETAILED DESCRIPTION

Road milling, mining, and trenching equipment utilizes bits and/or picks traditionally set in a bit assembly. Bit assemblies can include a bit and/or pick retained within a bore in a base block. For rotating bits, a slotted retainer, sleeve, and washer disposed circumferentially around the bit shank, for example, have typically been used to maintain the bit in the bit holder. Due to excess axial movement, however, gaps form between a bottom of the bit body, the washer, and a forward face of the bit holder and between a distal end of a sleeve and a forward end of a retainer, allowing dirt, debris, and fines to enter the space between the outer diameter of the bit shank and the inner diameter of the retainer, resulting in poorer rotation of the bit, reducing the life of a carbide tip of the bit and increasing the bit holder bore wear, thereby requiring replacement of the bit, bit holder, and/or base block long before the standard minimum lifetime required by the industry.

To prolong the life of the bit assembly, and the bit holder and/or the base block, a bit and/or pick comprising a washer feature incorporated into the body of the bit adjacent a distal end of the bit body, and a slotted retainer with varying features adjacent a distal end of the retainer will ease the insertion of the bit into the bit holder. The bit comprising the bit body including the integral washer feature of the present disclosure reduces the number of components that need to be manufactured and assembled, lowers manufacturing costs, allows faster manufacturing processes, provides more efficient bit performance, requires fewer bit replacements, and allows better bit rotation. Complete consumption of the usable carbide bit tip is possible due to the improved bit rotation and the larger and wider washer feature of the bit body. The integral bit body/washer design of the bit of the present disclosure decreases the number of components in the bit assembly, thereby allowing accurate, repeatable axial movement limits that are application specific.

The bit of the present disclosure also reduces axial movement and forms nearly 100 percent sealed areas between the inner diameter of the retainer and the outer diameter of the shank, between the bottom of the bit body and the retainer, and between the retainer and the bore of the bit holder, thereby providing nearly 100 percent uninhibited rotation of the bit, increasing the life of the bit tip insert of the bit due to improved rotation, and increasing the overall life span of the bit, bit holder, and base block. The reduced axial movement of the bit body allows an angled portion at a distal end of the washer feature to engage an angle or countersink at a forward end of the bore of the bit holder. The axial movement of the bit of the present disclosure is less than the axial length of the angled portion at the distal end of the washer feature of the bit body of the bit.

After the bit is inserted into the bore of the bit holder, the retainer is axially fixed in place in a rearward seated position. The axial movement of the bit body is then strictly controlled by the allowable clearance between a forward shoulder of the bit shank and a distal shoulder of the bit shank and the overall length of the retainer. The maximum manufactured tolerance deviation between the dimensions of the forward shoulder and distal shoulder of the bit shank and the overall length of the retainer in the illustrated exemplary embodiments of the bit described herein is approximately 0.030 inch.

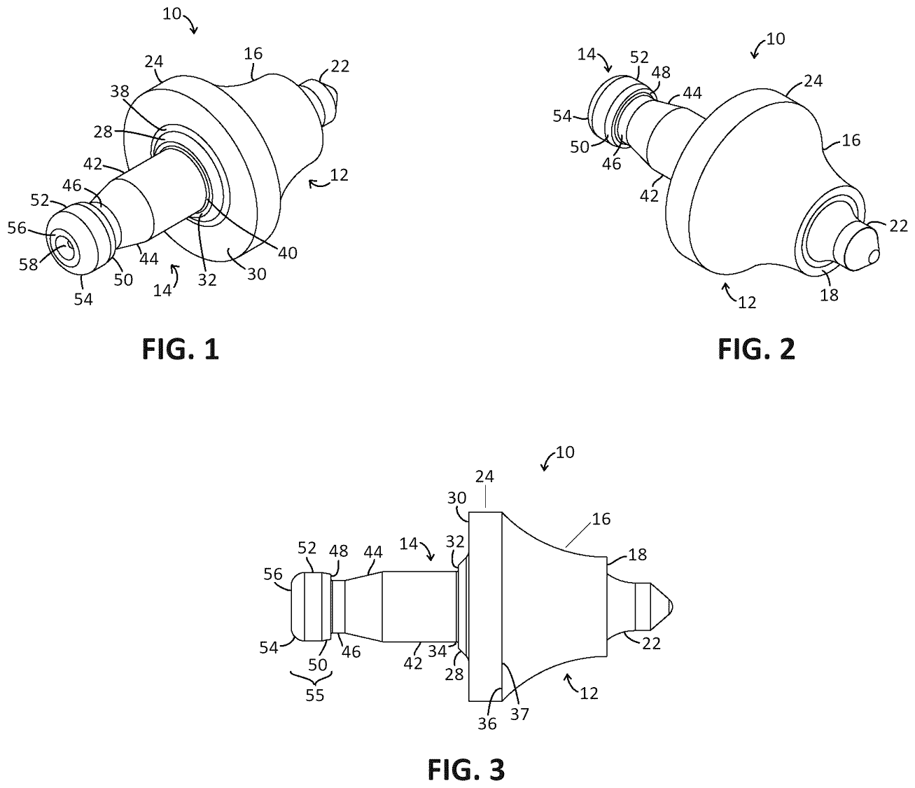

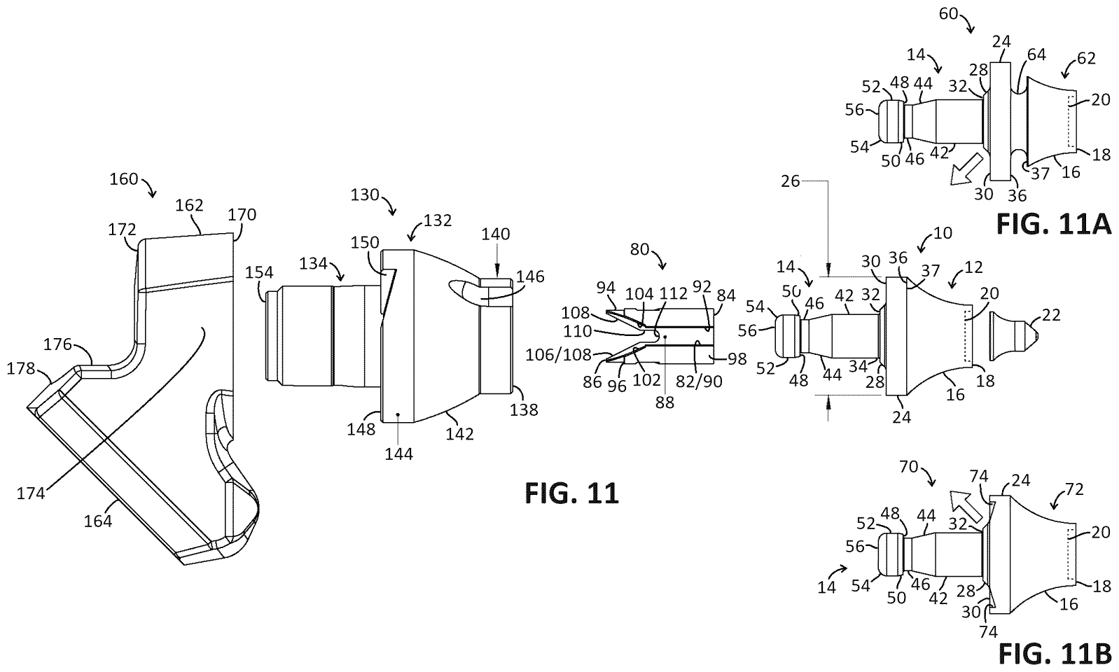

Referring to FIGS. 1-3 and 11-15, a first illustrated embodiment of a bit 10 is shown in accordance with implementations of this disclosure. Bit 10 comprises a bit body 12 and a bit shank 14 axially depending from a bottom of the bit body 12. The bit body 12 is generally cylindrical or generally annular in shape and comprises an annular or generally cylindrical top surface or forward end 18, such as a nearly flat annular top surface in the first illustrated embodiment, adjacent to an arcuate or concave forward body portion 16 that includes an annular or generally cylindrical trough 20 (FIG. 11) in which to retain a bit tip 22. The arcuate or concave forward portion 16 generally slopes axially and radially outwardly to a radially extending generally cylindrical enlarged washer feature or portion 24.

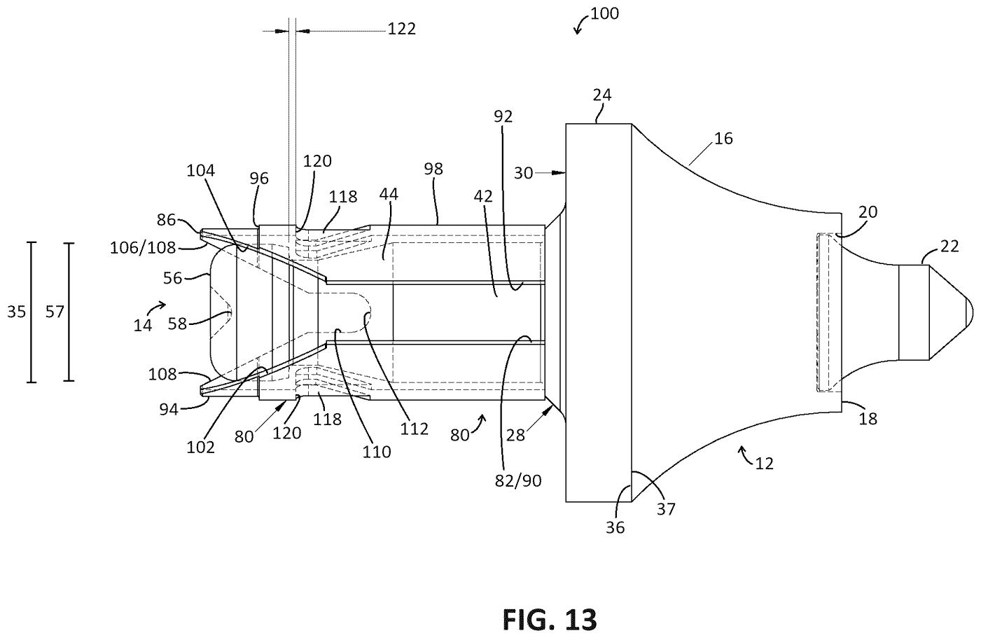

The washer feature 24 comprises a diameter 26 (FIG. 11) that, in this illustrated exemplary implementation, is generally the same as a diameter of a nose portion or upper body portion 140 of a bit holder 130. In other embodiments, the diameter of the washer feature 24 can be at least the diameter of the nose portion 140 of the bit holder 130 or greater than the diameter of the nose portion 140 of the bit holder 130. A decreased diameter tapered distal portion 28 (FIGS. 3 and 13) extends from a first flange 30 of the washer feature 24 to a second flange 32 at a forward end 34 of the shank 14. In this illustrated exemplary implementation, the thickness or axial length of the washer feature 24, measured from the first flange 30 to a forward end 36 of the washer feature 24, is generally from about 3/16 inch to ⅝ inch and is application specific. The first flange 30 and the second flange 32 may be flat, annular, and/or generally cylindrical flanges. The first flange 30 includes a first transition radius 38 laterally adjacent a forward end of the tapered distal portion 28. The first transition radius 38 is a small radius that transitions from the rear annular flange 30 to the tapered distal portion 28. The second flange 32 also includes a second transition radius 40 laterally adjacent the forward end 34 of the bit shank 14. The second transition radius 40 is also a small radius that transitions from the second flange or shoulder 32 to the shank 14.

A unibody is formed in that the washer feature 24 is designed as part of the bit body 12, thereby eliminating any opening and/or space between a distal end 37 of the forward body portion 16 and the adjacent forward end 36 of the washer feature 24. When the washer feature 24 is incorporated into the bit body 12 as a single component design, the cost of the unibody, i.e., the washer feature 24 and the bit body 12 combination, is about 20% less cost than the two-part washer and cutter bit body configuration of the prior art.

The bit shank 14, shown in FIGS. 1-3, 11, 13, and 15, axially depends from the second transition radius 40 of the second flange 32 adjacent the decreased diameter tapered distal portion 28 of the washer feature 24 and is axially aligned with the bit body 22. The shank 14 comprises a generally cylindrical first segment 42 that axially extends from the transition radius 40 of the second flange 32 to a tapered second segment 44. The second segment 44 axially extends from the first segment 42 to a generally cylindrical third segment 46. The third segment 46 axially extends from the second segment 44 to a third flange 48. An outwardly tapered fourth segment 50, adjacent the third flange 48, axially extends to a generally cylindrical fifth segment 52. The fifth segment 52 axially extends to an arcuate sixth segment 54 that is adjacent to a distal end 56 of the shank 14. The shank 14 includes a notch 58 (FIGS. 1, 13, and 15) that extends inwardly from the distal end 56. In other embodiments, the shank 14 can include generally cylindrical, tapered, and/or arcuate segments or any combination of same.

The shank 14 includes a coaxial and generally cylindrical collapsible slotted retainer, which in this exemplary illustrated implementation includes retainer 80 as described below, that is disposed circumferentially about the shank 14. In other embodiments, the retainer can include any of the retainers described in Applicant's patents and patent applications incorporated herein by reference in their entireties as described above. The retainer 80 is generally made from spring steel or other hardenable material with an elasticity and a durability that allows the retainer 80 to return to its nearly original shape despite significant deflection and/or twisting.

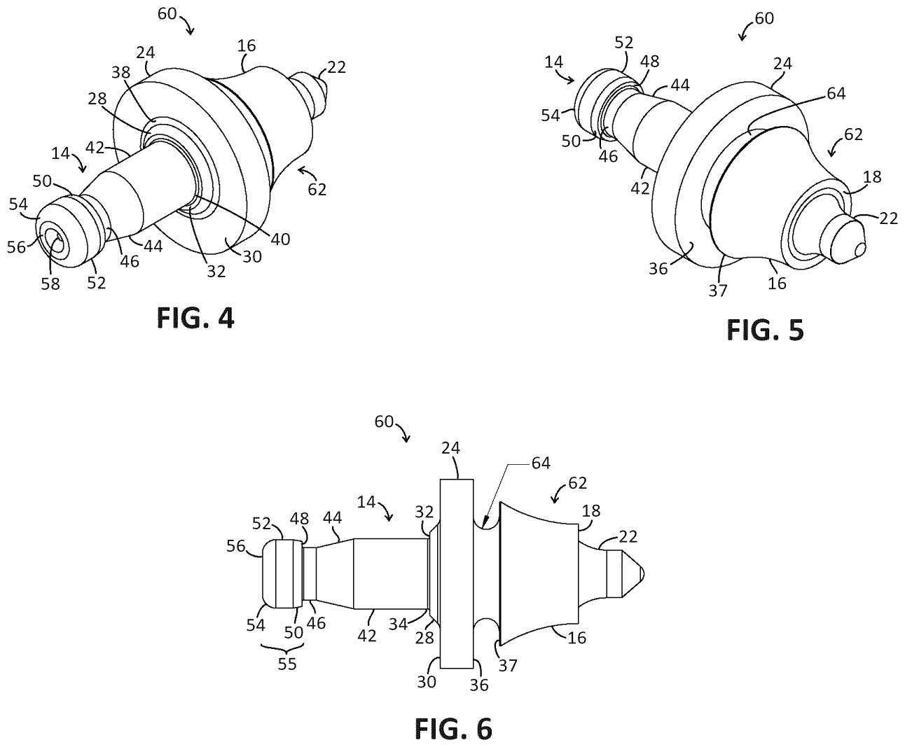

Referring to FIGS. 4-6, a second illustrated embodiment of a bit 60 is shown in accordance with implementations of this disclosure. Bit 60 is substantially the same as the first illustrated embodiment of the bit 10 with an exception that a bit body 62 of the bit 60 comprises a concave surface or annular groove 64 disposed between the arcuate forward portion 16 and the forward surface 36 of the washer feature 24. This groove 64 provides a space for a tool to extract the bit 60 from the bit holder 130.

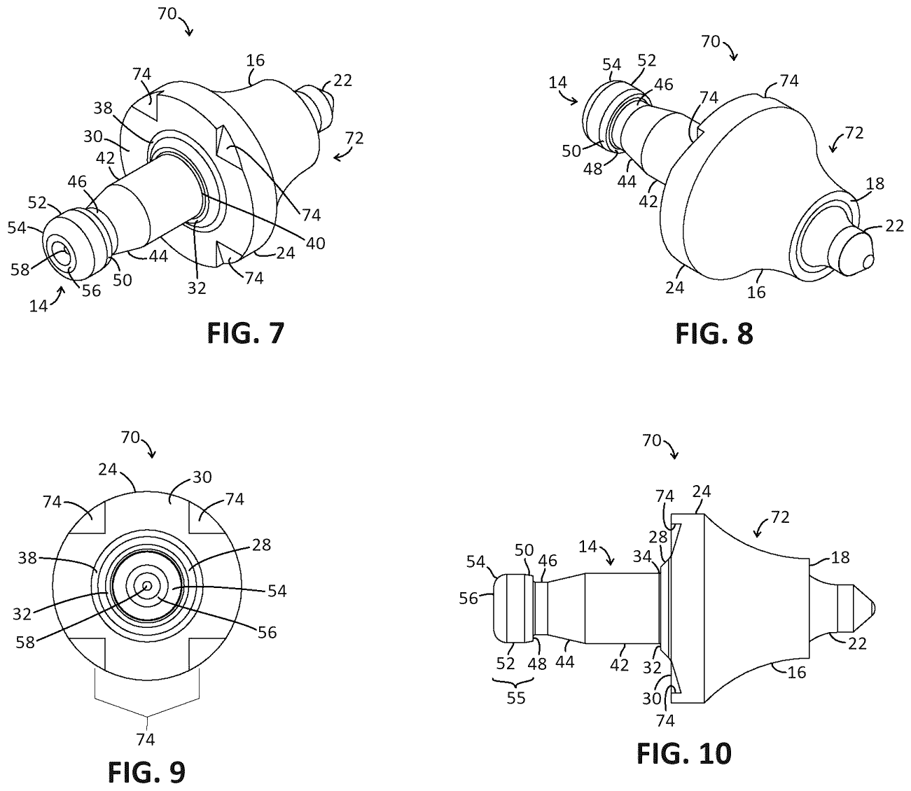

Referring to FIGS. 7-10, a third illustrated embodiment of a bit 70 is shown in accordance with implementations of this disclosure. Bit 70 is substantially the same as the first illustrated embodiment of the bit 10 with an exception that a bit body 72 of the bit 70 comprises a plurality of tapered cutouts 74, or wedge-shaped undercuts or knockout notches, to provide access and leverage for a tool to extract the bit 70 from the bit holder 130, described below. In this exemplary illustrated implementation, the bit body 72 includes four equally spaced tapered cutouts 74. The tapered cutouts 74 are formed into the washer feature 24 and extend from the first flange 30 adjacent to the washer feature 24. Each tapered cutout 74 includes a flat vertical inner surface and a flat tapered top surface. The outer edge of the flat tapered top surface of each tapered cutout 74 is arcuate in shape to follow the periphery of the washer feature 24.

Referring to FIGS. 11-15, a first illustrated embodiment of the retainer 80 is shown in accordance with implementations of this disclosure. Retainer 80 comprises a slot 82 axially extending from a forward end 84 of the retainer 80 to a distal end 86 of the retainer 80. The slot 82 comprises a gap profile 88 that is defined by a first radial end surface 90 of the slot 82 and a second radial end surface 92 of the slot 82. In this exemplary illustrated implementation, the radial end surfaces 90, 92 are linear throughout their axial length thereby defining a linear gap profile 88. In alternate embodiments of the retainers, such as those described in Applicant's patents applications and patents incorporated by reference above, the radial end surfaces 90, 92 and the gap profile 88 may be parallel, serpentine, arcuate, angular, zig-zagged, or any other configuration that can be formed by the radial end surfaces 90, 92 of the slot 82 or any combination of same.

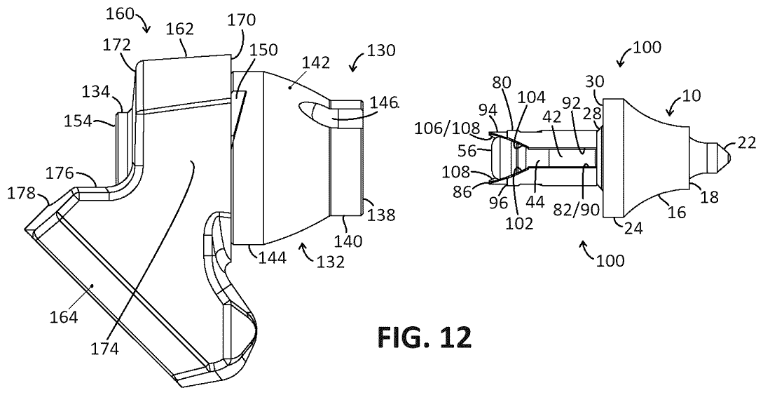

The retainer 80 comprises a reduced diameter distal section 94 adjacent the distal end 86 of the retainer 80. The reduced diameter distal section 94 axially extends to an annular or stepped shoulder 96 disposed between the reduced diameter distal section 94 and an outer surface 98 of the retainer 80. The annular shoulder 96 increases, or steps up, as it axially extends from the reduced diameter distal section 94 to the outer surface 98 of the retainer 80, the reduced diameter distal section 94 of the retainer 80 thereby comprising a thickness (not shown) and an outer diameter (not shown) that are less than a thickness (not shown) and an outer diameter (not shown) of the rest of the retainer 80, thereby allowing a small amount of radial interference between the reduced diameter distal section 94 of the retainer 80 and a bore 152 of the bit holder 130 upon initial manual insertion of the bit 10, 60, 70 into the bore 152 of the bit holder 130 and allowing the initial manual insertion of the bit 10, 60, 70 into the bore 152 of the bit holder 130 regardless of whether the bit holder 130 is new or used. In this exemplary illustrated implementation, for illustration purposes only, the thickness of the reduced diameter distal section 94 can be in the range of and including 0.002-0.045 inch on a retainer 80 including a thickness of 0.050 inch. The reduced diameter distal section 94 allows about 50% less distal end 86 contact at an outer surface of the reduced diameter distal section 94 of the retainer 80 with the inner wall of the bore 152 of the bit holder 130, which is beneficial during the initial manual insertion of the retainer 80 into the bore 152 of the bit holder 130. The reduced outer diameter of the reduced diameter distal section 94 not only allows for easier insertion of the bit 10, 60, 70 into the bore 152 of the bit holder 130, but also does not restrict the amount of axial insertion of the bit 10, 60, 70 into a first illustrated embodiment of a bit/retainer assembly 100 (FIG. 12). Additionally, by eliminating the need to use a washer to precompress the retainer, retainer 80 not only reduces the manufacturing cost of the first illustrated embodiment of the bit/retainer assembly 100, but is also more end-user friendly during the insertion, even manual insertion, of the bit 10, 60, 70 into the bit holder bore 152 that is either new, used, or at the end of its useful life while still retaining the bit 10, 60, 70 within the bore 152 of bit holder 130 by radial interference with the outer surface 98 of the retainer 80.

The retainer 80 is made of a material that allows the retainer 80 to act like a spring. The retainer 80 can be compressed to a certain degree and still bounce back to nearly its original configuration when the compression is released. A heat-treated retainer will allow more radial compressibility without taking a permanent set than a non-heat-treated retainer. The type of material used to make the retainer and the material's alloy constituents determine the impact value, strength, and radial compressibility of the retainer. In this exemplary illustrated implementation, retainer 80 is made from 6150 steel, a highly alloyed steel, providing the retainer 80 with a higher impact value and a higher strength, thereby allowing the retainer 80 to withstand a greater radial load without going beyond its yield limit and taking a permanent set, providing better overall performance over the life and use of the retainer as compared with the non-alloy materials used for prior art retainers, and extending the life of the bit holder 130 and/or a prior art bit holder in which it is used. In other embodiments, the retainers described and/or incorporated by reference herein can be made with any other suitable material as well.

The retainer 80 further comprises a first angled portion 102 that extends from the distal end 86 of the retainer 80 to the first radial end surface 90 of the slot 82 and a second angled portion 104 that extends from the distal end 86 of the retainer 80 to the second radial end surface 92 of the slot 82. A dual corner break is formed by the first angled portion 102 and the second angled portion 104, which allows for good and/or easier insertion of the distal end 86 of the retainer 80, disposed circumferentially about the shank 14 of the bit 10, 60, 70, into the bore 152 of the bit holder 130. The bit 10, 60, 70 comprises the enlarged washer feature 24 that includes a diameter that is generally the same as or larger than a diameter of the nose portion 140 of the bit holder 130 and, in this exemplary illustrated implementation, the shank 14 of the bit 10, 60, 70 comprises a forward diameter 35 (FIG. 11) that is greater than or equal to a distal diameter 57 of a cap 55 of the shank 14 adjacent the distal end 56 of the shank 14, the cap 55 comprising the outwardly tapered fourth segment 50, the generally cylindrical fifth segment 52 and the arcuate sixth segment 54.

The retainer 80 comprises a relief notch or v-notch 106, which is angular in this exemplary illustrated implementation, extending from the distal end 86 of the retainer 80. The relief notch 106 comprises a pair of angular sides 108 that extend from the distal end 86 of the retainer 80 to a compression slot 110. The compression slot 110 axially extends from a central portion or vertex of the relief notch 106 to a slot termination 112 adjacent the distal end 86 of the retainer 80. The relief notch 106 and compression slot 110 can axially extend from the distal end 86 of the retainer 80 and the relief notch 106, respectively, towards the forward end 84 of the retainer 80. The axial length of the relief notch 106 and the axial length of the compression slot 110 are application specific and may be of variable length, allowing the slot termination 112 to be disposed anywhere along the axial length of the retainer 80. Due to the omission of a washer, an axially longer relief notch and/or compression slot are used to reduce the retainer compression strength at the distal end 86 of the retainer 80 and allow easier retainer insertion into the bore 152 of the bit holder 130.

The retainer 80 further comprises at least one axially and radially inwardly extending axial locator tab 114 comprising a forward end that is a predetermined distance from the forward end 84 of the retainer 80. In this exemplary illustrated implementation, retainer 80 comprises two axial locator tabs 114 that each axially extend to a distal end 116 of the tab 114 adjacent the distal end 86 of the retainer 80 and are approximately 180 degrees apart, in this exemplary illustrated implementation, from one another. The distal ends 116 of the tabs 114 are disposed a predetermined distance from the forward end 84 of the retainer 80 and control the axial movement of the bit body 12, 62, 72 during use such that the axial movement of the bit shank 14 is less than the axial length 122 (FIG. 13) of the angle extending from the rear annular flange 30 of the bit body 12 and is generally about 0.030 inch of axial movement for this design.

The two axial locator tabs 114 are each radially inwardly positioned on a portion of the retainer 80, each forming a tab aperture 118 on the wall of the retainer 80 that terminates at a distal end 120 of the tab aperture 118. The distal ends 116 of the tabs 114 are adapted to engage the recess or third flange 48 on the bit shank 14 adjacent the distal end 56 of the bit 10, 60, 70 to prevent the retainer 80 from being removed from the bit shank 14 when the bit 10, 60, 70 is in use and when it is extracted from the bore 152 of the bit holder 130. In the exemplary illustrated embodiments described and/or incorporated by reference herein, the retainers include two or three axially and radially inwardly extending tabs. In other embodiments, the retainer 80 can include any number of axially and radially inwardly extending tabs. In yet another embodiment, the retainer 80 can comprise at least one aperture (not shown) that is a predetermined distance from the forward end 84 of the retainer 80. In yet other embodiments, the retainers described herein can simply comprise a generally cylindrical collapsible body portion and a slot that axially extends along the length of the retainer and creates a narrow gap between opposing sidewalls or radial end surfaces of the slot, the slot comprising a gap profile defined by the opposing sidewalls with various possible configurations and/or combinations as described above. These hollow retainers described and/or incorporated by reference herein with simply a slot along the axial length of the retainer from its forward end to its distal end are positioned on the shank of the bit between two vertical shoulders that are spaced axially to allow bit rotation while in use. The retainer can include the standard square corner or square end surface and/or can include any of the features described in Applicant's patents and patent applications incorporated herein by reference in their entireties as described above.

As with the embodiments of the retainers described and/or incorporated by reference herein, the reduced diameter distal section 94 allows less distal end 86 contact at the contact surfaces formed by the reduced diameter distal section 94 of the retainer 80 with the inner wall of a countersink 136 of the bore 152 of the bit holder 130, which is beneficial during the initial insertion of the retainer 80 into the bore 152 of the bit holder 130. During insertion, the direction of collapse (not shown) is radial, occurring initially adjacent the distal end 86 of the retainer 80. The addition of the reduced diameter distal section 94, the dual corner break formed by the first angled portion 102 and the second angled portion 104, the relief notch 106, and the compression slot 110 allows for easier insertion of the distal end 86 of the retainer 80 into the bore 152 of the bit holder 130.

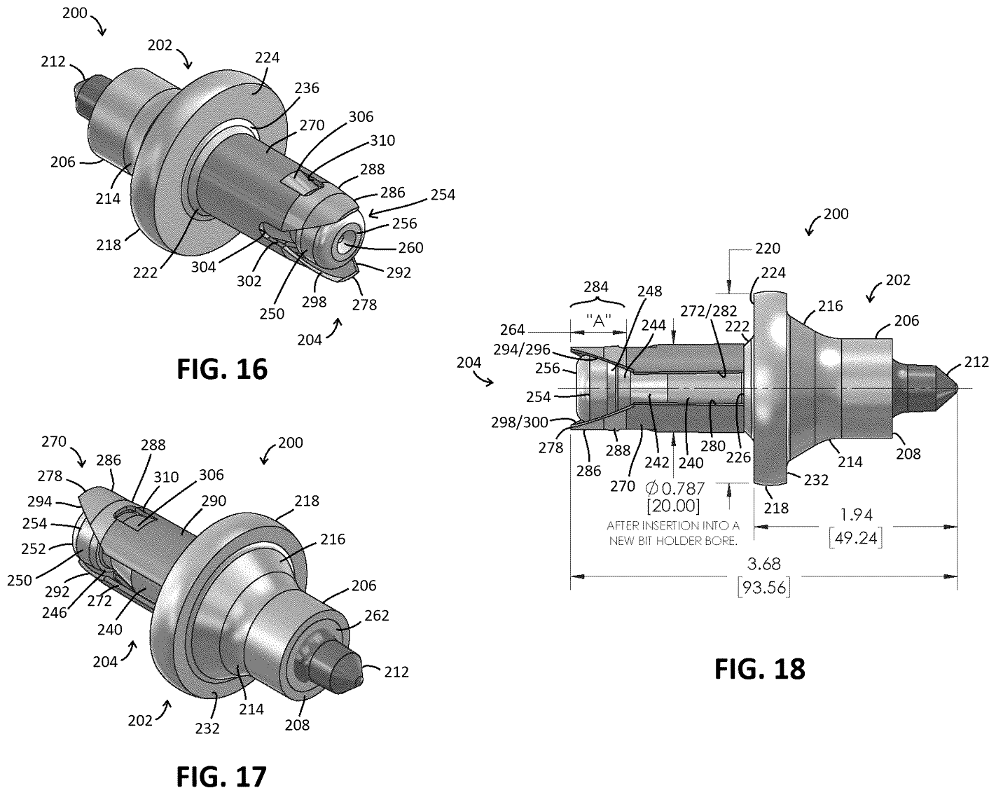

Referring to FIGS. 16-18, a fourth illustrated embodiment of a bit 200 comprises a bit body 202 and a bit shank 204 axially depending from a bottom of the bit body 202. The bit body 202 is generally cylindrical or generally annular in shape and comprises an annular or generally cylindrical top surface or forward end 208, such as a nearly flat annular top surface in this fourth illustrated embodiment, adjacent to an annular or generally cylindrical upper body portion 206 that includes an annular or generally cylindrical trough (not shown) in which to retain a bit tip 212. An arcuate or concave first mediate body portion 218 adjacent the upper body portion 206 generally slopes axially and radially outwardly to an angular or conical second mediate body portion 216. In other embodiments, the first mediate body portion 214 and the second mediate body portion 216 can have a frustoconical shape, an arcuate shape, a convex shape, a concave shape, and/or any combination of same. The angular body portion 216 extends axially to a forward surface 232, which is angular and/or planar in this exemplary illustrated implementation, of a radially extending generally arcuate enlarged washer feature or portion 218. The angular forward surface 232 of the washer feature 218 serves as a cut-material flow barrier that axially forces a rear annular flange 224 of the bit body 202 against a forward face of the bit holder with a greater force than a frustoconical profile on the forward end of the bit body. A unibody is formed in that the washer feature 218 is designed as part of the bit body 202. When the washer feature 218 is incorporated into the bit body 202 as a single component design, the cost of the unibody, i.e., the washer feature 218 and the bit body 202 combination, is about 30%-40% less cost than a two-part washer and cutter bit body configuration of a bit of the prior art.

The washer feature 218 comprises an outer diameter 220 that is, in this exemplary illustrated implementation, generally the same as a diameter of a nose portion of the bit holder, as shown in FIG. 18. In other embodiments, the diameter of the washer feature 218 can be at least the diameter of the nose portion of the bit holder and/or greater than the diameter of the nose portion of the bit holder. The washer feature 218 of the bit body 202 is located in a forward position from the first flange 224, which denotes a bottom of the bit body 202. A decreased diameter tapered or angular distal portion 222 extends from the first flange 224 of the washer feature 218 of the bit body 202 to a second flange 226 at a distal end of the angular portion 222 adjacent a forward end of the shank 134 as shown in FIG. 18. In this exemplary illustrated implementation, the thickness or axial length of the washer feature 218, measured from the first flange 224 to the forward surface 232 of the washer feature 218, is generally from about ⅛ inch to ½ inch and is application specific. The first flange 224 and the second flange 226 may be flat, annular, generally cylindrical, and/or any other suitable shape and/or configuration. In this exemplary illustrated implementation, the first flange 224 includes a first transition radius or undercut 236 (FIG. 16) laterally adjacent a forward end of the tapered distal portion 222. The first transition radius 236 is a small radius that transitions from the rear annular flange 224 to the tapered distal portion 222. The second flange 226 also includes a second transition radius or undercut (not shown) laterally adjacent the forward end of the bit shank 204. The second transition radius is also a small radius that transitions from the second flange or shoulder 226 to the forward end of the shank 204.

The bit shank 204 axially depends from the second transition radius of the second flange 226 adjacent a distal end of the decreased diameter tapered distal portion 222 and is axially aligned with the bit body 202. The shank 204 comprises a generally cylindrical first segment 240 that axially extends from the second transition radius of the second flange 226 to a tapered second segment 242. The second segment 242 axially extends from the first segment 240 to a generally cylindrical third segment 244. The third segment 244 axially extends from the second segment 242 to a third flange 246 (FIG. 17). An outwardly tapered fourth segment 248, adjacent the third flange 246, axially extends to a generally cylindrical fifth segment or cap 250 comprising an arcuate or radiused distal end 252 adjacent a distal end 256 of the bit shank 204. The shank 204 further includes a notch 260 that extends axially inwardly from the distal end 256 of the bit shank 204. In other embodiments, the shank 204 can be generally cylindrical and/or can include cylindrical, tapered and/or arcuate segments.

The bit 200 comprises the enlarged washer portion 218 that includes a diameter that is generally the same as or larger than a diameter of the nose portion 140 of the bit holder 130 and, in this exemplary illustrated implementation, the shank 204 of the bit 200 also comprises a diameter along the first segment 240 that is at least a diameter of the cap or fifth segment 250 of the bit shank 204. In other words, a distal diameter of a distal hub or cap 254 of the shank 134, which includes the outwardly tapered fourth portion 248, the generally cylindrical fifth segment 250, and the radiused portion 252 adjacent the distal end 256 of the shank 204 of the bit 200 in this illustrated implementation, is equal to or less than the forward diameter of the shank 204 along the first segment 240.

The distal hub or fifth segment 250 of the shank 204 including a similar or smaller diameter than the forward portion or first segment 240 of the shank 204, such as shown in this exemplary illustrated implementation of the fourth illustrated embodiment of the bit 200 where the cap diameter of the fifth segment 250 is less than the diameter of the first segment 240 of the shank 204, reduces and/or eliminates the interference of cutting fines accumulating between an outer diameter of the of the distal end or fifth segment 250 of the shank 204 and an inner diameter of a retainer disposed circumferentially around the bit shank 204.

In this exemplary illustrated implementation, the shank 204 includes a second illustrated embodiment of a coaxial and generally cylindrical collapsible slotted retainer 270 disposed circumferentially about the shank 204. The second illustrated embodiment of the retainer 270 includes a slot 272 axially extending from a forward end 276 of the retainer 270 to a distal end 278 of the retainer 270. The slot 272 comprises a gap profile that is defined by a first radial end surface 280 of the slot 272 and a second radial end surface 282 of the slot 272. In this exemplary illustrated implementation, the radial end surfaces 280, 282 are linear throughout their axial length thereby defining a linear gap profile. In alternate embodiments, the radial end surfaces and the gap profile may be parallel, serpentine, arcuate, angular, zig-zagged, or any other configuration that can be formed by the radial end surfaces 280, 282 of the slot 272 or combination of same.

The retainer 270 comprises a reduced diameter distal section 284 adjacent the distal end 278 of the retainer 270. In this exemplary illustrated implementation, the reduced diameter distal section 284 is generally cylindrical and may comprise a generally cylindrical outer surface 286 adjacent the distal end 278 of the retainer 270 and a tapered outer surface 288 adjacent the generally cylindrical outer surface 286. In other embodiments (not shown), the reduced diameter distal section 284 may comprise a first tapered outer surface adjacent the distal end 278 of the retainer and a second tapered outer surface adjacent the first tapered outer surface and/or any combination of generally cylindrical outer surfaces and/or tapered outer surfaces. The tapered outer surface 288 of the reduced diameter distal section 284 comprises an outward taper as it axially extends to an outer surface 290 of the retainer 270 and/or an inward taper as it axially extends from the outer surface 290 of the retainer 270 towards the generally cylindrical outer surface 286 of the reduced diameter distal section 284. The tapered outer surface 288 of the reduced diameter distal section 284 may comprise a shallow taper that eventually meets and/or terminates at the full diameter of a tapered region (not shown) of the outer surface 290 of the retainer 270 adjacent the reduced diameter distal section 284. Due to this tapered region of the outer surface 290 of the retainer 270, the forward end 276 of the retainer 270 is larger than the concentric radial reduced diameter distal section 284 of the retainer 270, thereby allowing higher radial retention force to be applied at the forward end 276 of the retainer 270 and a gradual diminishing radial force applied towards the distal end 278 of the retainer 270.

In this exemplary illustrated implementation of the second illustrated embodiment of the retainer 270 assembled onto the shank 204 of the fourth illustrated embodiment of the bit 200, the tapered outer surface 288 of the reduced diameter distal section 284 may comprise 5-50% of an axial length of the retainer 270. The tapered outer surface 290 of the retainer 270 is inwardly tapered towards the distal end 278 of the retainer 70 and may comprise, in this exemplary illustrated implementation, a taper in the range of and including nearly zero degrees to five degrees. In other implementations, the outer surface 290 of the retainer 270 may include tapers of varying degrees. Due to the tapered outer diameter profile of the retainer 270, the slot 272 is wider at the forward end 276 of the retainer 270.

The reduced diameter distal section 284 of the retainer 270 comprises a thickness and an outer diameter that are less than a thickness and an outer diameter of the rest of the retainer 270, thereby allowing a small amount of radial interference between the generally cylindrical outer surface 286 of the reduced diameter distal section 284 of the retainer 270 and the bore of the bit holder upon initial manual insertion of the bit into the bore of the bit holder and allowing the initial manual insertion of the bit into the bore of the bit holder regardless of whether the bit holder is new or used. In this exemplary illustrated implementation, the thickness of the reduced diameter distal section 284 of retainer 270 can be in the range of and including 0.002-0.045 inch on a retainer 270 including a thickness of 0.050 inch. The reduced diameter distal section 284 allows about 50% less distal end 278 contact at a first contact surface (not shown) and a second contact surface (not shown) on the retainer 270 with the inner wall of the bore of the bit holder, which is beneficial during the initial insertion of the retainer 270 into the bore of the bit holder. The reduced outer diameter of the reduced diameter distal section 284 not only allows easier insertion of the bit into the bore of the bit holder, but also does not restrict the amount of axial insertion of the bit into a bit/retainer assembly.

The retainer 270 further comprises a first angled portion 292 that extends from the distal end 278 of the retainer 270 to the first radial end surface 280 of the slot 272 and a second angled portion 294 that extends from the distal end 278 of the retainer 270 to the second radial end surface 282 of the slot 272. A dual corner break 296 is formed by the first angled portion 292 and the second angled portion 294, which allows for good and/or easier insertion of the distal end 278 of the retainer 270, disposed circumferentially about a shank of the bit, into the bore of the bit holder such as those in Applicant's co-pending applications described and incorporated herein by reference in their entireties.

The retainer 270 comprises a relief notch or v-notch 298, which is angular in this exemplary illustrated implementation, extending from the distal end 278 of the retainer 270. The relief notch 298 comprises a pair of angular sides 300 that extend from the distal end 278 of the retainer 270 to a compression slot 302. The compression slot 302 axially extends from a central portion of the relief notch 298 to a slot termination 304 adjacent the distal end 278 of the retainer 270. The relief notch 298 and compression slot 302 can axially extend from the distal end 278 of the retainer 270 and the relief notch 298, respectively, towards the forward end 276 of the retainer 270. The axial length of the relief notch 298 and the axial length of the compression slot 302 are application specific and may be of variable length, allowing the slot termination 304 to be disposed anywhere along the axial length of the retainer 270. Due to the omission of a washer, an axially longer relief notch and/or compression slot are used to reduce the retainer compression strength at the distal end 278 of the retainer 270 and allow easier retainer insertion into the bore of the bit holder. The “V” shaped cutouts, such as the dual corner break 296 and the relief notch 298, designed into the distal end 278 of the retainer 270 further improve bit rotation when using the reduced diameter section 284 adjacent the distal end 256 of the shank 204.

The retainer 270 further comprises at least one axially and radially inwardly extending axial locator tab 306 comprising a forward end that is a predetermined distance from the forward end 276 of the retainer 270. In this exemplary illustrated implementation, retainer 270 comprises two axial locator tabs 306 that axially extend to a distal end of the tab 306 adjacent the distal end 278 of the retainer 270 and are approximately 180 degrees apart from one another. The distal ends of the tabs 306 are disposed a predetermined distance from the forward end 276 of the retainer 270 and control the axial movement of the bit body 202 during use. The two axial locator tabs 306 are each radially inwardly positioned on a portion of the retainer 270, each forming a tab aperture 310 on the wall of the retainer 270 that terminates at a distal end of the tab aperture 310. The distal ends of the tabs 306 are adapted to engage the recess or flange 246 on the bit shank 204 adjacent the distal end 256 of the bit 200 to prevent the retainer 270 from being removed from the bit shank 204 when the bit 200 is in use and when it is extracted from the bore of the bit holder. In other embodiments, the retainer may include any number of axially and radially inwardly extending tabs. In yet another embodiment, the retainer can comprise at least one aperture (not shown) that is a predetermined distance from the forward end of the retainer. In yet other embodiments, the retainer may simply comprise a generally cylindrical collapsible body portion and a slot that axially extends along the length of the retainer and creates a narrow gap between opposing sidewalls or radial end surfaces of the slot, the slot comprising a gap profile defined by the opposing sidewalls with various possible configurations and/or combinations as described above. These hollow retainers described herein with simply a slot along the axial length of the retainer from its forward end to its distal end are positioned on the shank of the bit between two vertical shoulders that are spaced axially to allow bit rotation while in use.

The retainer is generally made from spring steel or other hardenable material with an elasticity and a durability that allows the retainer to return to its nearly original shape despite significant deflection or twisting. The retainer 270 is made of a material that allows the retainer 270 to act like a spring, such that the retainer 270 can be compressed to a certain degree and still bounce back to nearly its original configuration when the compression is released. The strength and compressibility of the retainer is determined by the material used for the retainer and the final hardness of the retainer after heat treating or other hardenable process as is known in the art. A heat-treated retainer will allow more radial compressibility without taking a permanent set than a non-heat-treated retainer. The type of material used to make the retainer and the material's alloy constituents determine the impact value, strength, and radial compressibility of the retainer. In this exemplary illustrated implementation, retainer 270 is made from 6150 steel, a highly alloyed steel, providing the retainer 270 with a higher impact value and a higher strength, thereby allowing the retainer 270 to withstand a greater radial load without going beyond its yield limit and taking a permanent set, providing better overall performance over the life and use of the retainer as compared with the non-alloy materials used for prior art retainers, and extending the life of a bit holder in which it is used. In other embodiments, the retainer can be made with any other suitable material as well.

As with the embodiments of the retainers described herein, the reduced diameter distal section 284 allows less distal end 278 contact at the contact surfaces formed by the reduced diameter distal section 284 of the retainer 270 with the inner wall of a countersink of the bore of the bit holder, which is beneficial during the initial insertion of the retainer 70 into the bore of the bit holder. During insertion, the direction of collapse is radial, occurring initially adjacent the distal end 278 of the retainer 270. The addition of the reduced diameter distal section 284, the dual corner break 296, the relief notch 298, and the compression slot 302 allows for easier insertion of the distal end 278 of the retainer 270 into the bore of the bit holder such that the retainer 270 disposed about the bit shank 204 may be manually inserted into the bore of the bit holder an axial distance “A” 264 as shown in FIG. 18. It is to be understood that the dimensions in FIG. 18 are for illustrative and exemplary purposes only and merely represent one exemplary illustrated implementation of the bit and retainer assembly of the present disclosure.

Referring to FIGS. 11-12 and 14-15, the bit holder 130 includes a bit holder body 132 and a bit holder shank 134 axially depending from the bottom of the bit holder body 132. The bit holder body 132 is generally annular in shape and comprises the countersink 136 adjacent a top surface 138, such as a flat annular top surface, defining the forward end of the bit holder body 132. The annular or generally cylindrical nose portion or upper body portion 140 axially extends from the top surface 138 to an arcuate middle body portion 142 that extends axially and radially outwardly to a radially extending generally cylindrical tire portion 144. A pair of notches 146 are formed into the bit holder body 132 and extend from the flat annular top surface 138 through the upper body portion 140 and partly through the middle body portion 142, terminating at a point within the middle body portion 142. The notches 146 provide access and leverage for a tool to extract, or knock out, the bit 10, 60, 70 from the bit holder body 132. The bit holder 130 may have many other shapes that are proprietary in design and are application specific. Generally, the lure of the bit holders accepts universal shank designs that are application specific.

Adjacent the tire portion 144 is a flange 148, such as a flat annular flange, that denotes the bottom of the bit holder body 132. The tire portion 144 includes a pair of tapered cutouts 150, or wedge-shaped undercuts, to provide access and leverage for a tool to extract the bit holder 130 from a base block 160, described below. The tapered cutouts 150 are formed into the tire portion 144 and extend from the flange 148 adjacent to the tire portion 144. The tapered cutouts 150 include a pair of parallel flat vertical inner surfaces and a pair of flat tapered top surfaces. The outer edge of the flat tapered top surfaces of each tapered cutout 150 is each arcuate in shape to follow the periphery of the tire portion 144.

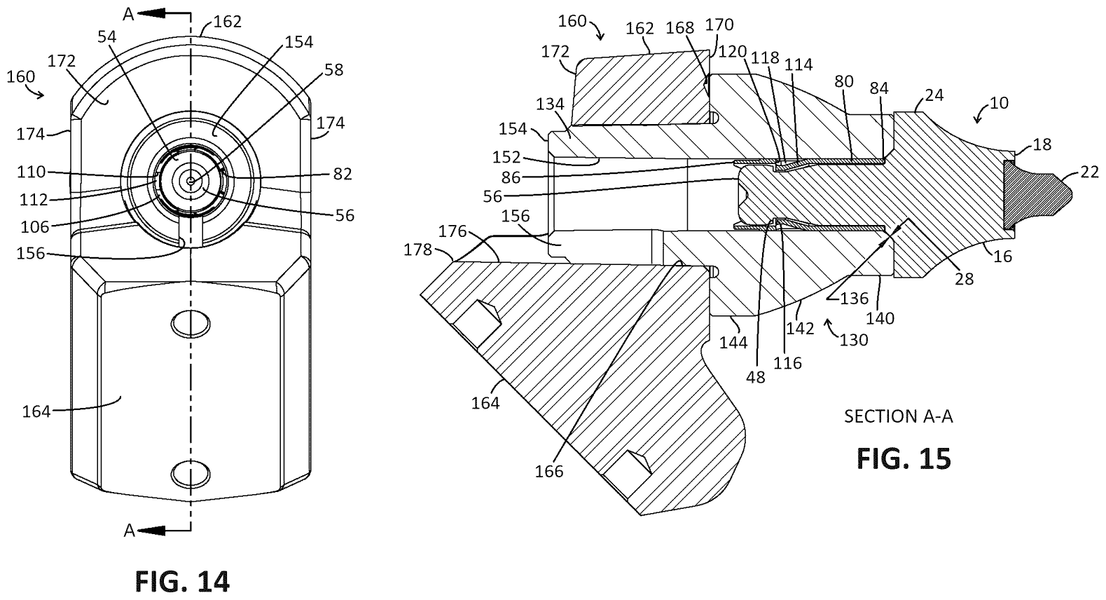

The bit holder shank 134 axially depends from the bit holder body 132. The bit holder body 132 and the shank 134 are axially aligned with the central bore 152 that extends from the countersink 136 adjacent the flat annular top surface 138 of the bit holder body 132 to a distal end 154 of the bit holder shank 134. In this illustrated embodiment, the shank 134 includes a shortened 1½ inch length. In other embodiments, the shank 134 can include the standard 2⅝ inch length or other suitable length. In this illustrated embodiment, the shank 134 also includes a slot 156 (FIG. 14) that extends from an upper termination (not shown) adjacent a forward end of the shank 134 to the distal end 154 of the shank 134. Optionally, or in an alternate embodiment, the shank 134 can also include an internally oriented second slot (not shown) that can be located approximately 180 degrees around the annular shank 134 from the slot 156. This second slot is parallel to the first slot 156 and is an internal slot having a rearward semicircular termination (not shown) inwardly adjacent to the distal end 154 of the shank 134 and a forward semicircular termination (not shown) generally coinciding longitudinally and axially with the upper termination of the slot 156.

Referring to FIGS. 11-12 and 14-15, the base block 160 comprises a shortened front end or shortened bit holder receiving portion 162 and a base 164. The base 164 can be flat or slightly concave to fit a drum or additional mounting plates on which a singular or a plurality of base blocks can be mounted. The shortened front end 162 includes a base block bore 166 (FIG. 15) that is symmetrical with the bit holder shank 134 along a centerline. The shortened front end 162 and the base block bore 166 extending axially through the shortened front end 162 are shortened to approximately 1.5 inches in length from a front face 170 of the base block 160 to a rear face 172 of the base block 160, in this illustrated embodiment, by removing material from the rear of the shortened front end 162. The shortened front end 162 includes, in this embodiment, an indentation 168 (FIG. 15) on the front face 170 of the base block 160. The shortened front end 162 also includes a pair of flat vertical sides 174 that extend near and/or adjacent to the base 164. The flat vertical sides 174 reduce the dimensions of the base block 160, including its width, and allow bit assemblies to be positioned in closer center-to-center axial bit tip orientation in order to degrade the road to a smoother surface.

The base block 160 also includes an arcuate bore extension 176 starting at an inner portion of the base block bore 166 adjacent the rear face 172 of the shortened front end 162 and extending toward a rear 178 of the base block 160. The extension 176 does not serve a function when the base block 160 is used with a shortened shank bit holder such as bit holder 130 described above. However, over time the extreme forces from cutting conditions will wear the base block bore 166 and bit holder shank 164 such that the shortened shank bit holder 130 may not successfully be retained in the base block bore 166 and the shortened shank bit holder 130 must be replaced with a standard 2⅝ inch length shank bit holder (not shown). The extension 176 engages the 2⅝ inch long shank of the standard bit holder adjacent its distal end and provides sufficient radial support against that portion of the shank to retain the standard bit holder in the base block bore 166.

Referring to FIG. 12, the first illustrated embodiment of the retainer 80 is assembled onto the bit shank 14 of the bit 10 to form the bit/retainer assembly 100 such that it is fully assembled prior to insertion into the bore 152 of the bit holder 130 without a washer. To mount the bit/retainer assembly 100 into the bore 152 of the bit holder 130, a user initially aligns the distal end 56 of the bit/retainer assembly 100 with the bore 152 of the bit holder 130 by hand and simply uses manual force to insert the reduced diameter distal section 94 of the retainer 80 into the bore 152 of the bit holder 130 until the annular shoulder 96 and/or the outer surface 98 of retainer 80 applies a sufficient amount of radial interference with the forward end of the bore 152 of the bit holder 130. After this initial manual insertion of the bit/retainer assembly 100 a short distance into the bore 152 of the bit holder 130, hammer strikes are needed to fully insert the bit shank 14 into the bore 152 of the bit holder 130 such that the first flange 30 of the bit 10 is fully seated on the top surface 138 of the bit holder 130. Upon full insertion, the retainer 80 applies sufficient radial force, as shown in FIG. 15, to retain the bit/retainer assembly 100 in the bore 152 of the bit holder 130 when the bit holder 130 is new, used, or at the end of its useful life, while still allowing uninhibited rotation of the bit 10 in the bore 152 of the bit holder 130. The tapered distal body portion 28 of the bit 10 and the countersink 136 of the bit holder 130 comprise matching contacting angles such that the two contacting surfaces of the tapered distal body portion 28 and the countersink 136 radially align the cutter bit body 12 concentric with the bore 152 of the bit holder 130.

Similarly, the second illustrated embodiment of the retainer 270 may be assembled onto the bit shank 204 of the bit 200 to form the bit/retainer assembly such that it is fully assembled prior to insertion into the bore 152 of the bit holder 130 without a washer. To mount the bit/retainer assembly into the bore 152 of the bit holder 130, a user initially aligns the distal end 256 of the bit/retainer assembly with the bore 152 of the bit holder 130 by hand and simply uses manual force to insert the reduced diameter distal section 284 of the retainer 270 into the bore 152 of the bit holder 130 until the annular shoulder 224 and/or the outer surface 290 of retainer 270 applies a sufficient amount of radial interference with the forward end of the bore 152 of the bit holder 130. During insertion, the direction of collapse is radial, occurring initially adjacent the distal end 278 of the retainer 270. The addition of the reduced diameter distal section 284, the dual corner break 296, the relief notch 298, and the compression slot 302 allows for even easier insertion of the distal end 278 of the retainer 270 into the bore of the bit holder such that the distal end 278 of the retainer 270 may be manually inserted into the bore 152 of the bit holder 130 an axial distance “A” 264 (FIG. 18). After this initial manual insertion of the bit/retainer assembly a distance “A” into the bore 152 of the bit holder 130, hammer strikes are needed to fully insert the bit shank 204 into the bore 152 of the bit holder 130 such that the first flange 224 of the bit 200 is fully seated on the top surface 138 of the bit holder 130. Upon full insertion, the retainer 270 applies sufficient radial force to retain the bit/retainer assembly in the bore 152 of the bit holder 130 when the bit holder 130 is new, used, or at the end of its useful life, while still allowing uninhibited rotation of the bit 200 in the bore 152 of the bit holder 130. The tapered distal body portion 222 of the bit 200 and the countersink 136 of the bit holder 130 comprise matching contacting angles such that the two contacting surfaces of the tapered distal body portion 222 and the countersink 136 radially align the cutter bit body 202 concentric with the bore 152 of the bit holder 130.

In bit-retainer-washer configurations of the prior art, the bore of the separate washer disposed around the retainer and shank of the bit controls the collapse of the retainer, thereby controlling whether the bit-retainer-washer configuration actually manually inserts within the bore of the bit holder. In contrast, the diameter of the reduced diameter distal section 94 of the retainer 80 is designed to always radially flex smaller than the diameter of the bore of the bit holder, thereby ensuring that the bit/retainer assembly 100 will radially flex and be retained within the bore of the bit holder.

As used in this application, the term “or” is intended to mean an inclusive “or” rather than an exclusive “or”. That is, unless specified otherwise, or clear from context, “X includes A or B” is intended to mean any of the natural inclusive permutations. That is, if X includes A; X includes B; or X includes both A and B, then “X includes A or B” is satisfied under any of the foregoing instances. In addition, “X includes at least one of A and B” is intended to mean any of the natural inclusive permutations. That is, if X includes A; X includes B; or X includes both A and B, then “X includes at least one of A and B” is satisfied under any of the foregoing instances. The articles “a” and “an” as used in this application and the appended claims should generally be construed to mean “one or more” unless specified otherwise or clear from context to be directed to a singular form. Moreover, use of the term “an implementation” or “one implementation” throughout is not intended to mean the same embodiment, aspect or implementation unless described as such.

While the present disclosure has been described in connection with certain embodiments and measurements, it is to be understood that the invention is not to be limited to the disclosed embodiments and measurements but, on the contrary, is intended to cover various modifications and equivalent arrangements included within the scope of the appended claims, which scope is to be accorded the broadest interpretation so as to encompass all such modifications and equivalent structures as is permitted under the law.

What is claimed is:

1. A retainer comprising:
a body portion comprising an axial forward end and an axial distal end;
a first slot extending through a sidewall of the body portion from the axial forward end to the axial distal end; and
a reduced diameter distal section adjacent the axial distal end of the retainer, the reduced diameter distal section comprising an outer diameter that is less than an outer diameter of the body portion of the retainer forward of the reduced diameter distal section.

2. The retainer of claim 1, the reduced diameter distal section comprising a generally cylindrical distal portion adjacent the axial distal end of the retainer and a tapered forward portion adjacent the generally cylindrical distal portion, the tapered forward portion including an outer surface that tapers axially inwardly as the outer surface axially extends to the generally cylindrical distal portion.

3. The retainer of claim 1, the body portion comprising an outer surface that tapers axially inwardly as the outer surface axially extends from the axial forward end towards the axial distal end.

4. The retainer of claim 1, the body portion comprising an outer surface adjacent the axial forward end that includes a taper greater than zero.

5. The retainer of claim 1, the reduced diameter further comprising at least one of:
a tapered portion tapered axially inwardly towards the axially distal end of the retainer; and
a generally cylindrical portion.

6. A bit comprising:
a unitary body portion comprising a washer portion adjacent a distal end of the unitary body portion, the washer portion integrally formed as part of the unitary body portion;
the unitary body portion axially and radially extending to a transition adjacent an outer diameter of the washer portion;
a generally cylindrical shank depending from a bottom of the body portion; and
a generally cylindrical hollow retainer disposed circumferentially about the shank, the retainer comprising:
a body portion comprising an axial forward end and an axial distal end;
a first slot extending through a sidewall of the body portion from the axial forward end to the axial distal end; and
a reduced diameter distal section adjacent the axial distal end of the retainer, the reduced diameter distal section comprising an outer diameter that is less than an outer diameter of the body portion of the retainer forward of the reduced diameter distal section.

7. The bit of claim 6, further comprising:
a tapered portion adjacent a rear annular flange of the washer portion, the tapered portion adapted to contact a countersink at a forward end of a bore of a bit holder to radially align the bit with the bore of the bit holder.

8. The bit of claim 7, further comprising at least one of:
a transition radius of the washer portion arcuately extending from the rear annular flange to the tapered portion, the transition radius of the washer portion comprising at least one of a planar outer surface, an arcuate outer surface, and an angular outer surface; and
a transition radius of the tapered portion extending from a shoulder at a distal end of the tapered portion to a forward end of the shank, the transition radius of the tapered portion comprising at least one of a planar outer surface, an arcuate outer surface, and an angular outer surface.

9. The bit of claim 7, the retainer further comprising:
a first angled portion extending from the axial distal end to a first radial end surface of the first slot; and
a second angled portion extending from the axial distal end to a second radial end surface of the first slot.

10. The bit of claim 6, the retainer further comprising:
a chamfer adjacent the axial distal end of the retainer, the chamfer extending to an outer surface of the retainer.

11. The bit of claim 6, the retainer further comprising:
a notch opposite the axial forward end of the retainer, the notch extending axially inwardly from the axial distal end of the retainer.

12. The bit of claim 11, the retainer further comprising:
a second slot axially extending from the notch through the sidewall of the retainer to a second slot termination, the second slot disposed approximately 180 degrees from the first slot.

13. The bit of claim 6, the retainer further comprising:
at least one tab disposed on a sidewall of the retainer, the at least one tab extending axially and radially inwardly, the at least one tab adapted to engage a flange adjacent a distal end of the shank of the bit to prevent the retainer from being removed from the shank.

14. The bit of claim 11, wherein the notch is one of arcuate and angular.

15. The bit of claim 11, the retainer further comprising:
a first angled side of the notch extending from a first location at the axial distal end of the retainer to a vertex of the notch axially inward from the axial distal end of the retainer; and
a second angled side of the notch adjacent the first angled side, the second angled side extending from a second location at the axial distal end of the retainer to the vertex, the first location spaced from the second location at the axial distal end of the retainer.

16. The bit of claim 6, further comprising:
an annular groove disposed between the forward body portion and the washer body portion.

17. The bit of claim 6, further comprising:
at least one pair of spatially related parallel undercuts extending inwardly from a bottom of said washer body portion, said undercuts comprising a hollow wedge shape.

18. The bit of claim 6, further comprising:
a washer diameter of the washer body portion adapted to be at least a forward diameter of a nose portion of a bit holder in which the bit is retained.

19. The bit of claim 6, the generally cylindrical shank comprising a forward portion and a cap portion adjacent a distal end of the shank, the forward portion of the shank comprising a forward diameter that is at least a cap diameter of the cap portion of the shank.
